(19) United States
(12) Patent Application Publication
(10) Pub. No.: US 2021/0097208 A1
(43) Pub. Date: Apr. 1, 2021

(54) Privacy Safeguards for Projecting Content onto a Shared Display Device

(71) Applicant: Microsoft Technology Licensing, LLC, Redmond, WA (US)

(72) Inventors: Tyler Joseph DONAHUE, Fall City, WA (US); William Scott STAUBER, Seattle, WA (US); Tyler Jeffrey WHITE, Seattle, WA (US); Benjamin Bear STOLOVITZ, Seattle, WA (US); Corey Joseph LOMAN, Seattle, WA (US); Christian KLEIN, Duvall, WA (US)

(21) Appl. No.: 16/588,919

(22) Filed: Sep. 30, 2019

(51) Int. Cl. G06F 21/84; G06F 3/14; G09G 5/14; G06F 21/62

(52) U.S. Cl. CPC G06F 21/84; G06F 3/1454; H04B 1/3827; G06F 21/6245; G09G 5/14

(57) ABSTRACT

A technique allows a user to project content onto a shared display region in a controlled manner. The technique involves receiving context information that describes a context in which a user is currently interacting with a local user computing device. The technique then determines, based on policy logic and the context information, whether it is appropriate to invoke a private state, or to remove the private state and enter a shared state. The private state involves presenting a privacy screen on one or more shared display regions. The local user computing device remains connected to the display device(s) that host the shared display region(s) while operating in both the private state and the shared state. According to one advantage, the technique eliminates or reduces the risk that the user will inadvertently release private information to others; further, it does so without asking the user to perform burdensome preparatory actions.

### BACKGROUND

A user can use different techniques to project content onto a shared screen provided by a display device. A shared screen corresponds to any display surface that is set up or otherwise intended for viewing by two or more people. For instance, assume that a user is currently located in a conference room and is interacting with a laptop computing device having a local display screen. Assume that the conference room also includes a projector device that displays a shared screen for viewing by all users in the conference room. The user may couple the laptop computing device to the projector device, e.g., by connecting the laptop computing device to the projector device via a physical cable. In one configuration, this action will prompt the laptop computing device to immediately mirror all content presented on the local display screen (of the laptop computing device) on the shared screen. The user can alternatively interact with an individual application running on the laptop computing device to cast content onto the shared screen, e.g., using application-specific functionality provided by the application. While widely used, these techniques sometimes fail to provide a satisfactory user experience.

### SUMMARY

A technique is described herein for controlling the projection of content onto a shared display region, e.g., by governing how information is shared when a local user computing device sets up a connection with a display device, and how information is shared during a user's subsequent interaction with that local user computing device. According to one illustrative implementation, the technique involves receiving plural signals that provide context information. The context information describes a context in which the user is currently interacting with the local user computing device. The technique then determines, based on policy logic and the context information, whether it is appropriate to invoke a private state, or to remove the private state and enter a shared state. The private state corresponds to a state in which the local user computing device displays a privacy screen on one or more shared display regions provided by one or more shared-region-hosting (SRH) display devices. The privacy screen blocks at least one display item that would be projected by the local user computing device to the shared display region(s), but for the privacy screen. In contrast, the shared state corresponds to a state in which the privacy screen (and the blocking function imposed thereby) is removed. The technique then displays content on the display device(s) in conformance with the identified state (e.g., either the private state or the shared state).

According to one illustrative feature, in the private state, the local user computing device displays one or more display items on one or more private display regions provided by one or more private-region-hosting (PRH) display devices. Simultaneously therewith, the privacy screen blocks the presentation of those display item(s) on the shared display region(s).

According to another illustrative feature, the technique can immediately enter the private state when the user first connects the local user computing device to an SRH display device, such as a conference room projector device. The technique can then transition to the shared state when the user gives an explicit command to do so, or when the user otherwise performs an action that evinces the user's intent to share content with others. The technique can transition back to the private state at any time, upon the user's explicit command to do so or upon the user performing an action that conveys his or her intent to hide content from others.

According to one illustrative advantage, the technique eliminates or reduces the risk that the user will inadvertently release private information to others. Private information corresponds to any content that the user wishes to conceal from others for any reason. Furthermore, the technique protects private information without asking the user to perform burdensome preparatory actions. For instance, the technique does not expect the user to disconnect the local user computing device from an SRH display device in order to block the presentation of private information. Nor does the technique ask the user to perform the disruptive operation of purging a private display region of personal content before connecting to the SRH display device. Still other advantages are set forth below in the Detailed Description.

The above-summarized technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 describes the operation of a presentation control system (PCS), in the context of one illustrative scenario.

FIG. 2 shows a state diagram used by the PCS to control the transition between a private state and a shared state.

FIG. 3 shows one implementation of the PCS of FIG. 1.

FIG. 4 shows various possible implementations of policy logic, which the PCS of FIG. 3 uses to determine whether to enter the private state or the shared state.

FIG. 5 shows additional illustrative components of the PCS of FIG. 3.

FIG. 6 shows an illustrative configuration user interface presentation that the PCS of FIG. 3 can present to a user.

FIG. 7 shows illustrative computing equipment that can be used to implement the PCS of FIG. 3.

FIG. 8 shows display devices that can be used to present content using the PCS of FIG. 3.

FIG. 9 shows an example of a local user computing device that provides at least one private display region and at least one shared display region.

FIG. 10 shows an example of a display device that provides plural shared display regions.

FIG. 11 shows an example of a display device that presents a mixed-reality environment, which, in turn, may host one or more private display regions and/or one or more shared display regions.

FIG. 12 is a flowchart that shows an overview of one manner of operation of the PCS of FIG. 3.

FIG. 13 is a flowchart that shows one manner of operation of the PCS with respect to a particular use scenario.

FIG. 14 shows an illustrative type of computing device that can be used to implement any aspect of the features shown in the foregoing drawings.

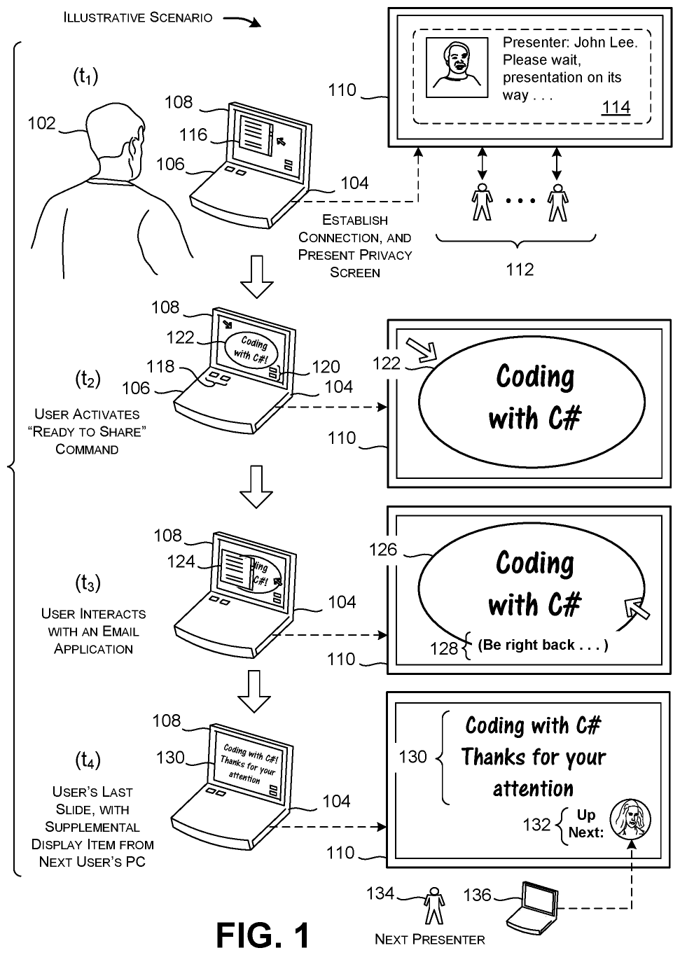

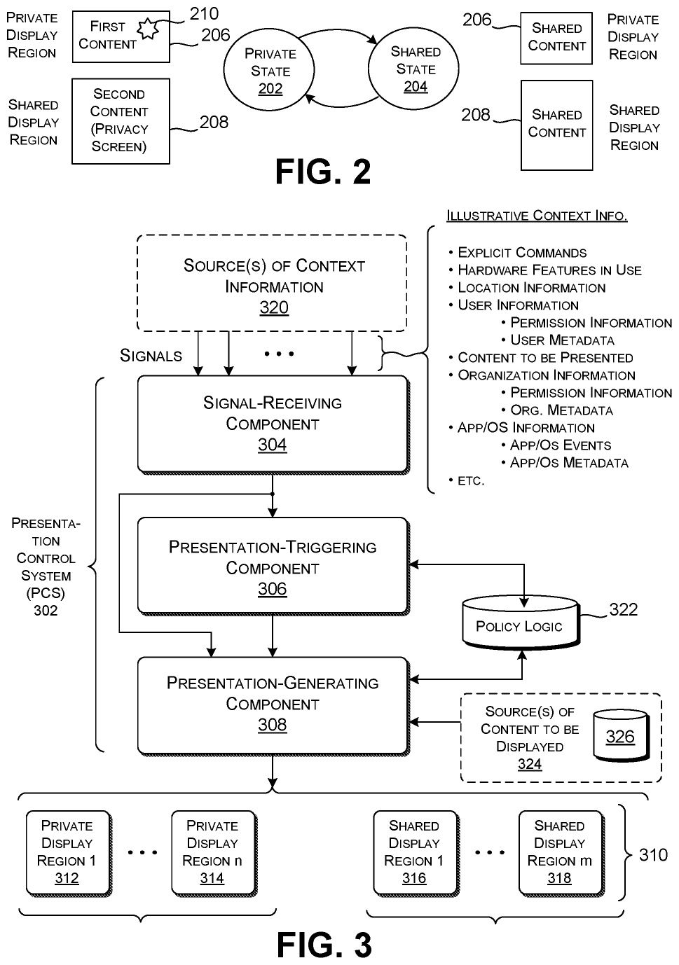

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computing system for controlling the projection of information onto display devices. Section B sets forth illustrative methods that explain the operation of the computing system of Section A. And Section C describes illustrative computing functionality that can be used to implement any aspect of the features described in Sections A and B.

As a preliminary matter, the term “hardware logic circuitry” corresponds to one or more hardware processors (e.g., CPUs, GPUs, etc.) that execute machine-readable instructions stored in a memory, and/or one or more other hardware logic units (e.g., FPGAs) that perform operations using a task-specific collection of fixed and/or programmable logic gates. Section C provides additional information regarding one implementation of the hardware logic circuitry. In some contexts, each of the terms “component,” “engine,” and “tool” refers to a part of the hardware logic circuitry that performs a particular function.

In one case, the illustrated separation of various parts in the figures into distinct units may reflect the use of corresponding distinct physical and tangible parts in an actual implementation. Alternatively, or in addition, any single part illustrated in the figures may be implemented by plural actual physical parts. Alternatively, or in addition, the depiction of any two or more separate parts in the figures may reflect different functions performed by a single actual physical part.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in Section C, which, in turn, can be implemented by one or more hardware processors and/or other logic units that include a task-specific collection of logic gates.

As to terminology, the phrase “configured to” encompasses various physical and tangible mechanisms for performing an identified operation. The mechanisms can be configured to perform an operation using the hardware logic circuitry of Section C. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry of Section C. When implemented by computing equipment, a logic component represents an electrical element that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Further, the term “plurality” refers to two or more items, and does not necessarily imply “all” items of a particular kind, unless otherwise explicitly specified. Finally, the terms “exemplary” or “illustrative” refer to one implementation among potentially many implementations.

A. Illustrative Computing System

FIG. 1 shows a scenario that conveys illustrative aspects of the operation of a presentation control system (PCS). (“Presentation” as used herein generally refers to providing information of any kind(s) in any context(s).) In this scenario, a user 102 performs a first operation by connecting a local user computing device 104 to a projector device (not shown) within a meeting room. For instance, the user 102 can perform this task by manually connecting these two devices together via a physical cable, such as a High-Definition Multimedia Interface (HDMI) cable. Alternatively, the local user computing device 104 can wirelessly connect to the projector device in automatic fashion, or upon instruction from the user 102.

In the merely illustrative case of FIG. 1, the local user computing device 104 corresponds to a laptop computing device having a key entry device 106 (such as a physical keyboard) and an optional local display device 108 (such as a Liquid-Crystal display (LCD) device). The local display device 108 presents content on a local screen. The projector device presents content on a shared screen 110. In this arrangement, the local display device 108 provides a private display region on the local screen, while the projector device provides a shared display region on the shared screen 110. A private display region corresponds to any display surface that is set up or otherwise intended to provide content for the consumption of a single user (e.g., the user 102). A shared display region corresponds to any display surface that is set up or otherwise intended to provide content for the consumption of two or more users, such as the user 102 and one or more other users 112 in the meeting room. In other cases, the user(s) 112 can interact with a version of the shared screen 110 from one or more remote locations, e.g., via their own respective user computing devices.

In the terminology used in this document, the local display device 108 is an example of a private-region-hosting (PRH) display device because it provides (or hosts) a private display region. The projector device is an example of a shared-region-hosting (SRH) display device because it provides (or hosts) a shared display region. Here, the PRH display device is a different physical device than the SRH display device. But in other cases, a single display device can host at least one private display region and at least one shared display region; this make the single display device both a PRH display device and an SRH display device. As will be clarified below, other applications of the PCS can omit the use of PRH display devices altogether.

The PCS operates at any given time in either a private state or a shared state. In the private state, the PCS displays a privacy screen on the shared display region of the shared screen 110. The privacy screen operates to block the projection of at least one display item by the local user computing device 104 (or other source(s)), which would occur but for the use of the privacy screen. The shared state removes the privacy screen, and therefore removes the blocking function performed by the privacy screen.

In the merely illustrative example of FIG. 1, in the private state, the PCS presents first content on the private display region and second content on the shared display region. The second content is different than the first content, at least in part, because it omits at least one display item that appears in the first content. Collectively, the second content is also referred to herein as a privacy screen. It constitutes a privacy screen insofar as it effectively blocks the projection of at least one display item, which would appear on the shared display region, but for the privacy screen. In the shared state, the PCS removes the privacy screen. This mirroring behavior is set forth in the spirit of illustration, not limitation. As will be clarified below, in other scenarios, the privacy screen can block the projection of content from the local user computing device 104 (or any other source), where that content does not concurrently appear on the private display region.

More specifically, in the concrete example of FIG. 1, at time t1 the PCS immediately invokes the private state when the local user computing device 104 connects to the projector device. This will cause the PCS to display a privacy screen 114 on the shared display region provided by the projector device. At the same time, the PCS (optionally) displays private content on the private display region provided by the local display device 108. In this case, the privacy screen 114 blocks the presentation of all of the private content that appears in the private display region, which would otherwise be projected onto the shared screen 110. In other cases, the privacy screen 114 can omit only some (but not all) of the private content that appears in the private display region. In still other cases, the privacy screen 114 blocks the projection of content on the shared display region that does not have counterpart content that concurrently appears in the private display region.

After connecting to the projector device, assume that the user 102 begins interacting with a file system provided by the local user computing device 104 to locate a desired slide deck. In response, the local user computing device 104 will display a user interface (UI) element 116 (such as a file-picker control element) that allows the user 102 to browse through files stored in the local user computing device 104. The privacy screen 114, by contrast, blocks the presentation of the UI element 116. Instead of the UI element 116, the privacy screen 114 shows default display content. Here, the default display content shows a picture of the user 102, together with textual information that describes user 102. The default display content also informs the other user(s) 112 in the meeting room that the user 102 is about to commence a presentation. Assume in this case that the presentation bears the title “Coding with C#.” This information is merely illustrative. For instance, assume that the current meeting represents a latest instance of a weekly meeting; here, the privacy screen can include notes from the prior week's instance of the meeting.

At time t2, assume that the user 102 performs an action that causes the PCS to transition from the private state to the shared state. For instance, the user 102 can issue an explicit command to enter the shared state, e.g., by activating a hard “share” key provided on the key entry device 106, by activating a soft “share” control element on a touch-sensitive surface provided by the local display device 108, performing a touch gesture on the touch-sensitive surface, issuing a voice command, and so on. The key entry device 106, for instance, may include two keys 118 that allow the user 102 to instruct the PCS to enter and leave the private state, respectively. The touch-sensitive surface provided by the local display device 108 includes two graphical control elements 120 that allow the user 102 to instruct the PCS to enter and leave the private state, respectively. Alternatively, the user 102 can perform an action that the PCS interprets as a request enter the shared state and commence sharing content with the other user(s) 112. For example, the user 102 can command a slide presentation application to begin a slide presentation; the PCS interprets this action as a request to enter the shared state. The PCS can invoke the private state in response to yet other factors, as will be described in greater below.

Upon entering the shared state, the PCS projects content from the local user computing device 104 to the shared display regions. In some but not all cases, this operation involves duplicating (mirroring) at least some of the content that is presented on the local screen (of the local display device 108) on the shared screen 110 (provided by the projector device). More specifically, the PCS can operate according to different screen-mirroring modes within the shared state. In a full-screen mirror mode, the PCS can duplicate all of the contents being presented on the local screen on the shared screen 110. In another mode, the PCS can duplicate only some information presented on the local screen on the shared screen 110. For example, the PCS can mirror just the content that is presented by a particular application. Or presume that the local user computing device 104 is currently configured to partition its display space on the local screen into two or more sub-screens; here, the PCS can mirror the contents of one or more sub-screens, but not necessarily all of the sub-screens. In an extend mode, a shared display region may represent, at least in part, an extension of a private display region. But to simplify the following explanation, assume that the PCS operates to mirror the entire contents of the local screen on the shared screen 110. In the specific example of FIG. 1, the local screen is currently showing the first slide 122 of the user's slide presentation, bearing the title “Coding with C#.” Upon entering the shared state, the PCS mirrors the content of the local screen such that the same slide 122 appears on the both of the local display screen and the shared screen 110. To repeat, the mirroring scenario shown in FIG. 1 is merely illustrative. In yet other cases, the PCS projects content from the local user computing device 104 without any expectation that the content is also presented on the local screen of the local user computing device. In the context of FIG. 1, this means that the PCS can project the first slide 122 of the presentation without also presenting this slide 122 on the private display region.

At time t3, assume that the user 102 decides to again enter the private state. For example, assume that the user 102 wants to interact with an Email application for some purpose that is related or unrelated to the presentation the user 102 is currently delivering to the user(s) 112. For instance, assume that the user 102 has received an urgent Email message from his son, and wishes to tend to this Email message during the course of his slide presentation. Further assume that the user 102 does not wish the other user(s) 112 to see the user's interaction with the Email application. For example, the user 102 may not wish to divulge the contents of any Email message to other people. Alternatively, or in addition, the user 102 may not wish to distract the other user(s) 112 by showing them user interface operations that are extraneous to the purpose of the user's presentation.

To enter the private state, the user 102 can make an explicit command to do so in any way described above. For example, the user 102 may press a hard “hide” key on the key entry device 106, or a graphical “hide” control element presented on the touch-sensitive surface. Alternatively, the user 102 can perform an action that the PCS automatically interprets as an attempt to enter the privacy state. For example, assume that the user 102 clicks on an icon associated with the Email application in a task bar (not shown) of the private display region. This will cause the Email application to display a graphical element 124 in the private display region. The PCS can interpret the user's activation of the Email application as an implicit request to enter the private state. This, in turn, will cause the PCS to display a new privacy screen in the shared display region. The privacy screen blocks the graphical element 124 presented in the private display region from appearing in the shared display region. Again, the PCS can decide to invoke the private state in response to yet other triggering factors, as will be described below.

In this merely illustrative case, the privacy screen includes a static image of the last slide 126 that the user 102 presented in the shared display region, prior to activating the Email application. The privacy screen also optionally includes a message “Be right back . . . ” 128 that alerts the other user(s) 112 that the user 102 has temporarily suspended the slide presentation. In another case, the message 128 can alert the other user(s) 112 of the general task that the user 102 is performing without otherwise divulging specific personal information, e.g., by reading “Be right back, I'm responding to an urgent Email.” The PCS can retrieve this default message from a lookup data store, based on knowledge that the user 102 has receive a message flagged as urgent (!) and based on the fact that the user 102 has activated the Email application. Or the user 102 can manually supply this message in real time, e.g., by typing it in via the key entry device 106.

Assume that after tending to the Email-related task, the user 102 closes the Email application and re-invokes the shared state. The user 102 can perform this task by issuing an explicit command to do so, or by performing an operation that the PCS interprets as request to enter the shared state. For example, the PCS can automatically re-invoke the shared state when the user 102 closes or minimizes the Email application.

At time t4, assume that the user 102 has finished his slide presentation. Assume that the private display region and the shared display region both show the last slide 130 of the user's presentation at this time. (In another case, note that the private display region need not show the last slide.) At this juncture, the PCS can again invoke the private state, causing it to generate a new privacy screen. Here, the privacy screen contains a “frozen” image of the last slide 130, or any other prior content presented in a current presentation session. Although not shown, the privacy screen can also include dynamically-changing information, such as questions by the other user(s) 112, which they have sent to the user 102.

The privacy screen also shows a message 132 that displays information regarding a next slide presentation (if any) to be delivered by another presenter. More specifically, assume that a new presenter 134 is set up to use her own local user computing device 136 to deliver her presentation. Further assume that the local user computing device 136 includes its own local instantiation of the PCS that presents the message 132 on the shared display region. The scenario in FIG. 1 therefore serves as an example in which two or more people can contribute to a shared display region. More specifically, FIG. 1 serves as an example in which two or more people may contribute to content presented on the same privacy screen. In another example, the PCS generates a split privacy screen having two parts. The user's PCS presents a first privacy screen on one half of the shared display region, while the next presenter's PCS presents a second privacy screen on the other half of the shared display region.

The PCS provides a number of advantages, which can be conveyed in the context of the above-described illustrative scenario. As an overall benefit, the PCS reduces the risk that he user 102 will inadvertently reveal private content on the shared display region to the other user(s) 112. This is because the PCS provides a mechanism (e.g., the privacy screen) for blocking the presentation of private information, either at the explicit request of the user 102 and/or in response to other contextual signals (described below).

As a related benefit, the PCS simplifies the user interface operations that the user 102 is expected to perform in the course of delivering shared content. For example, in previous approaches, a local user computing device may immediately begin mirroring everything that appears in its local screen on a shared screen when the local user computing device connects to a projector device. To guard against this outcome, the user would need to purge the local screen of any personal content prior to connecting to the projector device. Note that this problem also exists when the local user computing device projects content that does not have a visual counterpart on the local screen of the local user computing device. Here, there remains a risk that, upon connecting to a projector device, the local user computing device 104 may immediately start projecting private content on a shared screen. In the very least, the user may be unsure as to what content the local user computing device will choose to project on a shared screen when a connection is made. The PCS described above addresses this problem by immediately entering the private state when the user 102 connects the local user computing device 104 to the projector device. This manner of operation will block the presentation of private content on the shared display region. This also eliminates or reduces the need for the user 102 to perform preparatory user interface operations to remove private content from the private display region prior to connecting to the projector device, or to take special efforts to stop applications and other source(s) from sending private content to a shared display screen.

For related reasons, the PCS allows the user 102 to perform private transactions during the course of a presentation without revealing private content and without performing burdensome preparatory actions. In previous approaches, by contrast, a user 102 may block the presentation of private content by physically disconnecting the local user computing device from the projector device. This operation is burdensome for the user to perform. Moreover, it is disruptive to the flow of the user's presentation.

As a further advantage, the PCS allows the subsequent presenter 134 to connect to the projector device without disrupting an ongoing presentation being delivered by the first user 102. This is helpful because it facilitates the smooth transition between presenters. It also assures the new presenter 134 that she has successfully connected to the projector device in advance of the start of her presentation. In previous approaches, a next presenter may experience significant stress while waiting to deliver his or her presentation, being unsure as to whether he or she will encounter technical difficulties in setting up the presentation. In these approaches, the next presenter cannot connect to a projector device while a current presenter is presenting content because this act may cause that current presenter to be disconnected from the projector device. The first presenter can also benefit from the above-described system behavior. For instance, the first presenter can connect to the projector device a few minutes prior to the start of his presentation, but without yet showing the first slide of his presentation on the shared display region. This will help allay the first presenter's anxiety about successfully launching his presentation. In some implementations, the PCS can provide a confirmation message that informs a presenter when the local user computing device 104 has successfully connected to the projector device. For instance, the message 132 can serve this purpose.

As another benefit, the PCS provides a way of resolving conflicts between different components as to how and when information is projected on a shared display region. Without the use of the PCS, for example, an application and its operating system may provide conflicting rules as to the circumstances in which content is projected to a shared display region, leading to potential contention among different components. This potential conflict, in turn, may leave a user unsure of if, how, and when content will be projected onto the shared display region. The PCS described above resolves these issues by serving as a central agent that controls the presentation of content on private and shared display regions. For instance, an application may include a program function that operates to mirror content on a shared display region. When the user 102 invokes this feature, the PCS takes this event into account in determining how to present content on a shared display region, in possible conjunction with other contextual factors.

As another characteristic, note that, in presenting the shared state, the PCS partitions a display space into parts, including an optional private part (presented in the private display region(s)) and a shared part (presented in the shared display region(s)). The PCS can leverage the bifurcated nature of its display space to construct different kinds of privacy screens that complement different respective contexts and display objectives. In previous approaches, by contrast, an operating system treats display content to be displayed as a single undifferentiated block, that is, by presenting the same information on the local and shared screens. The use of a monolithic display space also means that an operating system cannot realize the kinds of complex display-related behaviors of which the PCS is capable.

The scenario shown in FIG. 1 can be varied in different ways. For instance, in the above scenario, the privacy screen corresponds to a resource that entirely blocks private content that is presented in the private display region. (More generally stated, the privacy screen entirely blocks all private content that would be projected to the shared display screen 110, but for the use of the privacy screen). In other cases, a privacy screen operates as a filter that prevents some of the content and operations from being shown on the shared display space, but not necessarily all of the content and operations. For example, consider the case in which the PCS invokes a privacy screen when the user 102 activates an Email application. The PCS can present a privacy screen that serves to filter out the user's interaction with the Email application, but exposes other actions that the user 102 performs in the private display region that are deemed permissible to share. For instance, the PCS can show at least some of the user's windowing operations. Alternatively, or in addition, the PCS can show the user's interaction with a file system of the local user computing device 104. To operate in this manner, the user 102 can designate these actions (moving a cursor and interacting with the file system, etc.) as permissible to share, e.g., via a prior configuration setting. Further note that the privacy screen in this example represents a dynamically-changing resource that reflects actions taken by the user 102. More generally, a privacy screen can dynamically change based on changes in any context factor(s).

Further, in the above scenario, the PCS displays content on a single private display region and a single shared display region. But in other cases, the PCS can display content on two or more private display regions and/or two or more shared display regions. In some implementations, the PCS can apply the same policy logic when presenting a privacy screen on plural shared display regions. That is, the PCS can display the same privacy screen in all shared display regions. But in other cases, the PCS can apply different rules to generate different respective policy screens for different respective shared display regions, based on one or more contextual factors described below.

In another variation, the PCS need not display content on any private display regions. That is, in the example of FIG. 1, the user can control the course of a slide presentation using the local computing device without showing any content on the local display device 108. In that case, the user can control the transitions between the private state and the shared state via the key entry device 106, via voice commands, etc.

Further, the PCS as described above controls the display of content on one or more display devices. In addition, the PCS can also control the presentation of information via any other output device or devices. For instance, the PCS can control the presentation of audio information on one or more speakers. Like the case of display information, the PCS can play shared audio output information on one or more shared audio output devices (e.g., external speakers), and play private audio output information on one or more private audio output devices (e.g., headphones).

Finally, note that the scenario of FIG. 1 has been described with the expectation that the user 102 is presenting content for the consumption of one or more other users 112. But in other cases, the user 102 may present content to a shared display region for his or her sole consumption. For instance, the user 102 may interact with a smartphone to project application content to a television set, irrespective of the presence of other users who may also see the application content once it is projected. In the broadest sense, a private display region and a shared display region may be regarded as a first display region and a second display region, respectively, the two display regions having different respective environment-specific uses.

Advancing now to FIG. 2, this figure shows a state diagram that explains the operation of the PCS from a high-level perspective. As noted above, the PCS transitions between a private state 202 and a shared state 204. In the private state 202, the PCS optionally displays first content in at least one private display region 206 and second content in at least one shared display region 208. The second content is also referred to as a privacy screen and blocks the presentation of at least one display element 210 that might be presented on the shared display region 208, but for the use of the privacy screen. In the shared state 204, the PCS removes the privacy screen. In one implementation, the PCS can display the same shared content in both the private display region(s) 206 and the shared display region(s) 208. More broadly stated, the shared state involves projecting content onto the shared display region(s) that would otherwise be blocked by the privacy screen.

FIG. 3 shows one implementation of a privacy control system (PCS) 302 that can deliver the user experience shown in FIG. 1. The PCS 302 includes three principal components: a signal-receiving component 304; a presentation-triggering component 306; and a presentation-generating component 308. By way of overview, the signal-receiving component 304 receives a plurality of signals that collectively convey context information. The context information, in turn, describes a context in which a local user computing device is currently operating in an environment, relative to one or more display devices on which it may present content. The presentation-triggering component 306 controls whether the local user computing device is operating in the private state or the shared state at any given moment. The presentation-generating component 308 generates content that is presented in one or more display regions 310. The display regions 310 includes one or more optional private display regions (312, . . . , 314) and one or more shared display regions (316, . . . , 318). One or more private-region-hosting (PRH) display devices (not shown) can provide the private display regions (312, . . . , 314), while one or more shared-region-hosting (SRH) display devices (not shown) can provide the shared display regions (316, . . . , 318). As noted above, a single display device may host a private display region and a shared display region, making that single display device both a PRH display device and an SRH display device. Each of the above components (304, 306, 308) will be described in greater detail below in turn.

The signal-receiving component 304 can receive different types of signals from different sources 320 of context information. The signal-receiving component 304 can use any technique(s) to receive these signals, such a pull-based technique, push-based technique, etc., or combination thereof. In a pull-based technique, the signal-receiving component 304 directly polls the signal source(s) 320 to collect the signals. In a push-based technique, the signal-receiving component 304 receives signals independently pushed to the signal-receiving component 304 by the signal source(s) 320.

The following provides a non-exhaustive list of illustrative signals that the signal-receiving component 304 can receive, along with their respective signal sources.

Explicit Commands. The signal-receiving component 304 can receive one or more signals when the user issues explicit commands to enter the private state or the shared state. For instance, the signal-receiving component 304 can receive a signal when the user activates a hard key on a local user computing device, or a graphical control element on a touch-sensitive display surface. The signal-receiving component 304 can receive these types of signals from the operating system of the local user computing device, which, in turn, receives input events when the user interacts with any type(s) of input device(s) to enter the commands.

Presentation Endpoint Information. The signal-receiving component 304 can receive one or more signals that reveal the kinds of display devices on which the local user computing device may project content. In one case, the signal-receiving component 304 uses a probing service provided by the local user computing device to interrogate nearby display devices. It can do this by receiving information from each nearby display device that identifies its type (e.g., by identifying it as a projector device, a television set, etc.). The probing service can receive information from a display device in different ways. For the case in which the local computing device is connected to the display device via a physical cable, the local user computing device can receive the information via that physical connection. Otherwise, the probing service can receive the information through any type of wireless connection (e.g., BLUETOOTH connection, WIFI connection, etc.).

Connection Events. The signal-receiving component 304 can receive one or more signals that reveal events in which the user manually connects the local user computing device to a display device, or disconnects the local user computing device from the display device. The signal-receiving component 304 can also receive one or more signals when the local user computing device automatically connects or disconnects from a display device. The signal-receiving component 304 can receive these types of signals from the operating system of the local user computing device.

The signal-receiving component 304 can also receive signals that identify the manner in which the user has coupled the local user computing device to an external display device. This information provides evidence as to whether the display device will be hosting a private display region or a shared display region. For example, assume that a user connects a laptop computing device to a television set via a docking device, such as the SURFACE DOCK device provided by MICROSOFT CORPORATION of Redmond, Wash. In some environments, a user may use a docking device primarily in private settings, reducing the probability that the user intends to project shared content on the television set.

Device Configuration Information. The signal-receiving component 304 can receive one or more signals that identify the physical configuration of any display device. For example, the signal-receiving component 304 can receive a signal that indicates that a display device of the local user computing device is orientated in such a manner that its display surface is directed outward, away from the user; this indicates that the user intends to utilize this display device to provide a shared display region. The signal-receiving component 304 can receive these types of signals from various sensors provided by the local user computing device (to be described below in greater detail in connection with the explanation of FIG. 9).

Application-Related Information. The signal-receiving component 304 can receive one or more signals that reveal the kinds of applications that are locally stored by the local user computing device, or which the local user computing device otherwise has access. The signal-receiving component 304 can receive these types of signals using a lookup service. The lookup service can directly probe the applications to extract metadata therefrom. In addition, or alternatively, the lookup service can receive information regarding any application by interrogating an application store or other repository from which the application was originally obtained or could be obtained. For instance, the PCS 302 can rely on this information to identify applications that typically involve presenting content on shared display regions, such as slide presentation applications.

Program Event Information. The signal-receiving component 304 can receive one or more signals that identify actions performed by the user in the course of interacting with one or more applications and/or operating system features. For example, a signal can identify a type of function that the user has invoked in the course of interacting with a particular application or operating system feature. In some cases, the signal can also explicitly indicate that the invoked function should be considered private or sharable. The signal-receiving component 304 can receive these types of signals from the operating system of the local user computing device.

User Interface State Information. The signal-receiving component 304 can receive one or more signals that describe the current configuration of a user interface presentation provided by a local display device (if any) associated with the local user computing device. For instance, a signal can identify whether the user is currently operating in a single-screen mode or a split-screen mode. One or more other signals can identify the number, arrangement, types, etc. of windows or other graphical objects that the user interface presentation is currently presenting. The signal-receiving component 304 can receive these types of signals from the operating system of the local user computing device.

Focus-of-Interest Information. The signal-receiving component 304 can also receive one or more signals that identify what window or other graphical object is presumed to be the user's current focus of interest. The signal-receiving component 304 can receive these types of signals from the operating system of the local user computing device. For instance, the operating system can include a focus analysis component (not shown) that provides one or more signals that identify the current presumed focus-of-interest of the user based on any of: information regarding the (x, y) position of windows (or other graphical objects) on a display screen; information regarding the z-order of windows (or other graphical objects) on a display screen (e.g., that identifies the window or other graphical object that has a top-most position, if any); information regarding the window (or other graphical object) with which the user is currently interacting, on so on.

Time Information. The signal-receiving component 304 can receive one or more signals that identify the current time, the current date, etc. The signal-receiving component 304 can receive these types of signals from any local and/or remote time-keeping device(s).

Location Information. The signal-receiving component 304 can receive one or more signals that identify the current location of the user. In addition, the signal-receiving component 304 can receive one or more signals that identify the location of each nearby display device (relative to the local user computing device). The signal-receiving component 304 can determine the location of the local user computing device using any type of position-determining mechanism provided by the local user computing device, such as a Global Positioning System (GPS) mechanism, a terrestrial wireless signal triangulation mechanism, a BLUETOOTH or WIFI beacon-detection mechanism (for instance), and so on. In one case, the PCS 302 can assume that the user is co-located with the local user computing device. The signal-receiving component 304 can determine the approximate location of a display device relative to the local computing device by receiving a signal emitted from this display device and measuring its strength.

User Presence Information. The signal-receiving component 304 can receive one or more signals that identify the presence of users in proximity to any given user, or the absence of any such other user. The signal-receiving component 304 can receive these types of signals directly from local user computing devices associated with nearby users. For example, a local user computing device can receive a wireless signal sent by a smartphone carried by a nearby user, which identifies the owner of the smartphone. Alternatively, or in addition, a nearby user can inform a central location service of its current location. The signal-receiving component 304 can receive a signal from that central location service that informs it of the nearby presence of another user. Alternatively, or addition, the signal-receiving component 304 can receive information from a calendar system that informs it of who is expected to appear at a current location (e.g., a current meeting room) at the present time.

User Permission Information. The signal-receiving component 304 can receive one or more signals that identify permission information associated with each nearby user. The permission information identifies whether it is appropriate for that nearby user to receive different types of content to be shared (by a sharing user). The signal-receiving component 304 can receive related signals that convey permission information that applies to an organization as a whole, or an identified group within an organization. The signal-receiving component 304 can receive these types of signals from a central data store that stores permission information associated with users, organizations, etc. Alternatively, or in addition, the signal-receiving component 304 can receive these types of signals directly from devices carried by the nearby users.

Content-Related Information. The signal-receiving component 304 can receive one or more signals that identify attributes regarding content items that a user wishes to share with others. For instance, such a signal may indicate that a content item includes confidential financial information that can be viewed by only certain people within an organization. The signal-receiving component 304 can receive these types of signals by directly interrogating metadata associated with content items. In addition, or alternatively, the signal-receiving component 304 can receive these types of signals from a data store that stores permission information on a per-content-item basis.

The above list of signals are provided by way of example, not limitation. Other implementations can collect additional types of signals compared to those described above, and/or omit one or more of the signals described above.

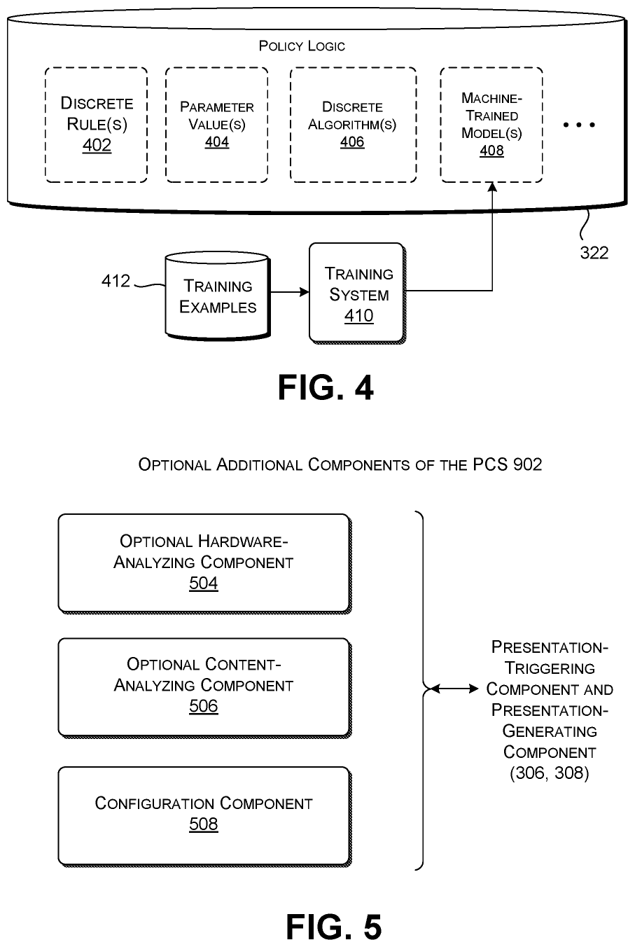

The presentation-triggering component 306 consults policy logic in a data store 322 to determine whether the PCS 302 should operate in the private state or the shared state at each given moment. Broadly stated, the presentation-triggering component 306 maps a set of input factors that describe the prevailing context into a conclusion as to whether to invoke the private state or the shared state. Advancing momentary to FIG. 4, the policy logic can take different forms, including a set of discrete rules 402, a set of parameter values 404, one or more algorithms 406, one or more machine-trained models 408, and so on, and any combination thereof. A collection or rules, parameter values, and/or algorithms may collectively define the state machine shown in FIG. 2. The data store 322 can be local with respect to a local user computing device, remote with respect to the local user computing device, or distributed among two or more locations. Further note that FIG. 4 shows a single instantiation of the policy logic to be applied in all environments. Alternatively, or in addition, the data store 322 can contain plural version of the policy logic to be applied in different respective environments (e.g., for use by different respective organizations).

Consider an illustrative implementation of the PCS 302 in which the policy logic includes a series of discrete IF-THEN-type rules. One or more rules specify that a specified state should be immediately enabled or disabled when the user issues an explicit command to that effect. One or more other rules indicate that the PCS 302 should enter the private state immediately after it has been determined that the user has connected a local user computing device to a SRH display device (such as a projection device), or when it has been detected that the local user computing device has automatically connected to the SRH display device. One or more other rules specify that the private state (or the shared state) should be enabled (or disabled) when the local user computing device is connected to a particular type of SRH display device, such as a projector device. One or more other rules specify that the private state (or the shared state) should be enabled (or disabled) when the user is interacting with particular kinds of applications or application functions. One or more other rules specify that the private state (or the shared state) should be enabled (or disabled) when the user is using the local user computing device in particular locations. One or more other rules specify that the private state (or the shared state) should be enabled (or disabled) when the user performs particular operating system functions (e.g., by opening a file browser utility, resizing a window, adjusting a configuration setting, etc.). One or more other rules specify that the private state (or the shared state) should be enabled (or disabled) when a particular user or users are located within a prescribed proximity to the user who is operating the local user computing device, and so on.

Still other rules handle the case in which two or more people are permitted to contribute to the same shared display region (e.g., as demonstrated by the behavior of the PCS 302 at time t4 in FIG. 1). For example, an illustrative rule instructs an SRH display device to present a privacy screen until everyone that is scheduled to contribute to a shared display region executes a “ready” command. Another illustrative rule specifies that a second presenter may contribute to a privacy screen when a first presenter has projected his or her last slide in a presentation (which is the case in the scenario shown in FIG. 1). Upon this triggering event, the first presenter's PCS will enter the private state and project a static image of the last slide of his presentation. The second presenter's PCS will also enter the private state, and can project any content to the shared privacy screen that notifies the audience that a new presentation is on its ways.

Still other rules handle conflicting outcomes among two or more other rules. One such general rule can indicate that, when a first rule specifies that the PCS 302 should enter a private state and a second rule specifies the PCS 302 should enter the shared state, the PCS 302 will enter the private state. Other rules may handle conflicts on a more granular basis, e.g., by providing a resolution that is specific to the two or more rules that are in conflict.

The above triggering rules are provided by way of example, not limitation. Other implementations can apply additional triggering rules compared to those described above, and/or can omit one or more of the rules described above.

Alternatively, or addition, the presentation-triggering component 306 can apply one or more machine-trained models 408, such as one or more machine-trained classification models. Illustrative types of machine-trained classification models include linear regression models, neural network models, support vector machine models, decision tree models, and so on. The presentation-triggering component 306 can apply a machine-trained model by first converting a set of prevailing contextual factors into a feature vector. For instance, the presentation-triggering component 306 can produce a feature vector having different dimensions associated with different contextual factors; the value of any given dimension indicates whether a particular condition exists or not. In some implementations, the value of a dimension of the feature vector can also specify the magnitude of a condition. The presentation-triggering component 306 can then use the machine-trained model to map the feature vector to an output conclusion as to whether the private state or the shared state should be invoked (or disabled).

A training system 410 produces a machine-trained model by iteratively operating on a set of training examples in a data store 412. More specifically, the training system 410 can produce a machine-trained model as an offline task. The training system 410 can also update any machine-trained model as new training examples are received, e.g., on a periodic basis or continuously. Each training example labeled as “true” includes a conclusion that specifies an appropriate state (“private” or “shared”) for a specified set of contextual factors. Each training example labeled as “false” includes a conclusion that specifies an incorrect state for a specified set of contextual factors. To generate an environment-specific model, the training system 410 specifically culls a set of training examples that express the behavior of users within that setting. The training system 410 can use any technique to produce the model, such as, without limitation, stochastic gradient descent. The training system 410 may express the model itself as a set of parameter values (e.g., including weighting and bias values).

The training system 410 ensures that policy logic adapts to changing presentation-related behavior within an organization or other setting. The PCS 302 can also provide learning functionality to update discrete rules, parameter values, etc. For example, the PCS 302 can determine the number of times that users modify a display configuration set up by the PCS 302, e.g., by removing a privacy screen automatically introduced by the PCS 302, or adding a privacy screen when the PCS 302 fails to do so. If the number of these “corrections” exceeds an environment-specific threshold value, the PCS 302 can modify a rule in the policy logic to express what is assumed to be the user's preferred display-related preferences.

Returning to FIG. 3, the presentation-generating component 308 controls the content that is sent to the display regions 310. The content may originate from various sources 324. Illustrative sources include an operating system of a local user computing device, an application running on the local user computing device, a content item stored on the local user computing device, a data store 326 (which may be local and/or remote from the local user computing device), and so on. The presentation-generating component 308 can specifically retrieve default display content from the data store 326 to construct a privacy screen. In other cases, two or more instantiations of the presentation-generating component 308 contribute content items from two or more local user computing devices associated with two or more respective users.

More specifically, to generate a privacy screen, the presentation-generating component 308 can draw from plural sources of information. For instance, the presentation-generating component 308 can construct a privacy screen that includes a default background image or video, selected by the user, and/or automatically selected by the PCS 302. In addition, or alternatively, the presentation-generating component 308 that can present information that describes the user who is currently presumed to be operating the local user computing device, e.g., by providing the user's name, title, organizational affiliation(s), contact information, etc. The presentation-generating component 308 can also include a picture of the user, an avatar associated with the user, etc. The PCS 302 can determine the person who is operating the local user computing device based on, for instance, identifying information that the person submits at the beginning of a presentation session. In addition, or alternatively, the presentation-generating component 302 can include information in the privacy screen that describes one or more other users who are presumed to be viewing a presentation. The PCS 302 can determine the presence of nearby users in any manner specified above, e.g., by detecting signals directly transmitting by devices carried by the users, based on calendar information, etc.

In addition, or alternatively, the presentation-generating component 308 can construct a privacy screen based on content selected from an ongoing slide presentation or other content being shared with other users. For example, the presentation-generating component 308 can include a static snapshot of an ongoing presentation, such as by providing an image of the last slide presented by the user upon transitioning from the shared state to the private state. Alternatively, or in addition, the presentation-generating component 308 can include a looping video that describes the last n seconds of the user's presentation, preceding the transition to the private state.

The presentation-generating component 308 can operate by applying policy logic stored in the data store 322 in constructing a privacy screen. More specifically, the policy logic includes two kinds of rules that control the behavior of the presentation-generating component 308. A first kind of rule determines what content is to be presented on a privacy screen based on different respective contextual factors. For instance, a first rule may specify that the privacy screen should include information IA for location LA and information IB for location LB. A second kind of rule determines how to arrange a set of selected content items on the privacy screen, given a set of contextual factors. The policy logic can take any form(s) described above, such as a set of IF-THEN rules.

In a multi-user scenario, one or more rules may specify whether two or more users are permitted to project information to a shared display region. If permitted, the presentation-generating component 308 can combine content from plural users in different ways. In one implementation, each local instantiation of the PCS (associated with each contributing user) provides content items that it displays in a particular section (e.g., a particular panel) of the privacy screen. In another case, a master presentation-generating component (not shown) can receive content items from plural local instantiations of the presentation-generating component 308. The master presentation-generating component can then apply policy logic to determine the manner in which it combines content items supplied by different contributors.

The above-described presentation construction rules are set forth by way of example, not limitation. Other implementations can apply additional rules compared to those described above, and/or can omit one or more of the rules described above.

FIG. 5 shows additional illustrative components 502 of the PCS 302 of FIG. 3, each of which is optional. The additional components 502 include an optional hardware-analyzing component 504 that makes a determination whether a particular display device is private or shared. A private display device presents a private display region, while a shared display device presents a shared display region. In one approach, the hardware-analyzing component 504 consults a predetermined setting that indicates whether a particular display device is to be considered private or shared. For instance, a laptop computing device can include a first setting that indicates that its attached display device is to be considered private by default. The laptop computing device can include a second setting that indicates that an external projector device (to which it my connect) is to be considered shared by default. In other cases, the hardware-analyzing component 504 can determine whether a display device is private or shared based on its location, orientation, etc. For example, the hardware-analyzing component 504 can identify a pivoting display device as shared if it is oriented outward, away from the user. Or the hardware-analyzing component 504 can consider a display device as shared when it is mounted in an area that is considered public, such a hallway. The hardware-analyzing component 504 can make the above decisions based on any manifestation(s) of the policy logic described above.

An optional content-analyzing component 506 determines whether a particular content item is to be considered private or shared. The content-analyzing component 506 can make this determination by analyzing metadata (if any) associated with the content item, e.g., which describes the permissions associated with the content item. Alternatively, or in addition, the content-analyzing component 506 can identify the type of the content item (e.g., based on its file extension and/or any other evidence), and then consult a rule to determine whether the content item is private or shared based on its type. Alternatively, or in addition, the content-analyzing component 506 can use a machine-trained model to determine whether a content item is private or shared. The machine-trained model can operate on a feature vector that describes any properties of the content item (its metadata, its internal content, etc.), source from which it is taken, the context in which it is to be presented, and so on. Further note that the content-analyzing component 506 can assign additional classification labels to a content item, e.g., beyond labeling it as private or shared. For example, the content-analyzing component 506 can use any technique described above to determine whether a slide represents the last slide in a deck.

Although not shown, a display-region-analyzing component can determine whether a portion of a multi-section display screen corresponds to a private section or a shared section. For example, consider a split-screen having a left section and a right section. The display-region-analyzing component can determine whether each section is being used to present private content or shared content. The display-region-analyzing component can perform this task using any of the techniques described above, such as by using discrete rules, a machine-trained model, etc. In one case, the display-region-analyzing component can determine that a section is private when it is predominantly used to display content items and/or to host application functions considered to be private. (Note that the same logic can be used by the hardware-analyzing component 504 to determine whether a display device as a whole is to be considered private or shared.)

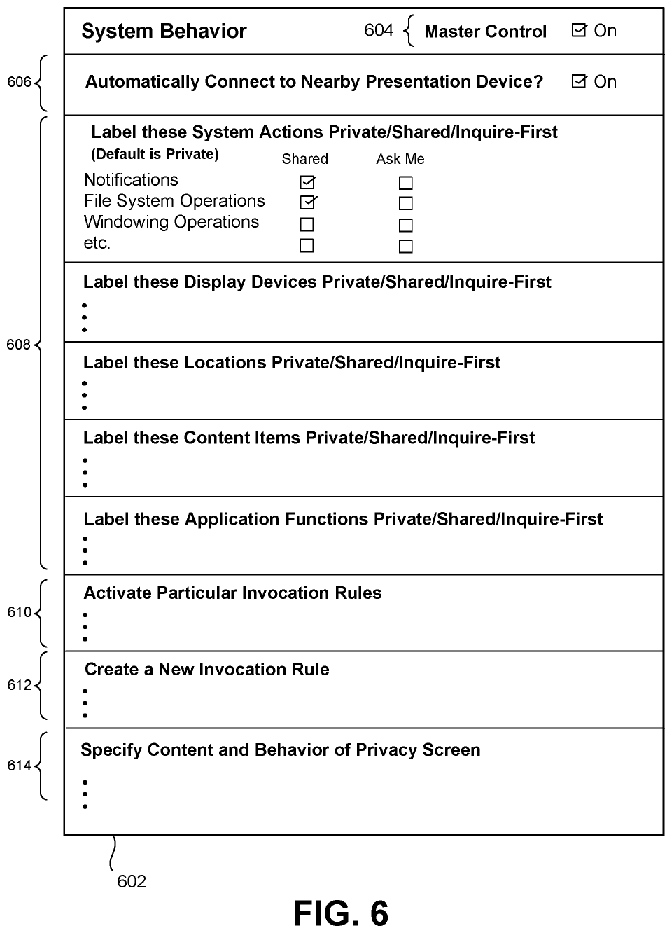

A configuration component 508 allows a user to customize any aspects of the policy logic. In one implementation, the configuration component 508 allows a user to configure the policy logic by means of one or more user interface presentations. FIG. 6 shows one illustrative and non-limiting user interface (UI) presentation 602 provided by the configuration component 508. The UI presentation 602 includes a master toggle control element 604 which allows the user to activate or deactivate the services of the PCS 302. When deactivated, the PCS 302 will not play a role in determining the content that is directed to different display regions. This means that, while deactivated, the local user computing device will not generate any privacy screens. More generally, while deactivated, the local user computing device will treat its display space as a contiguous (undifferentiated) domain.

A second toggle control element 606 allows a user to specify whether the local user computing device will attempt to automatically connect to an external (shared) display device when in the vicinity of that display device. When deactivated, the local user computing device will only connect to an external display device when the user explicitly makes such a connection (e.g., by manually connecting the local user computing device to the display device, or by issuing a command to wirelessly make the connection, etc.).

Other control elements allow the user to define the operation of the PCS 302 in a more granular manner. For instance, a set of graphical control elements 608 allows the user to label the following dimensions of context as either private or shared: system functions; application functions; display devices; locations; content items, etc. Or the user can specify that the PCS 302 is to ask the user whether a particular action or entity is to be considered private or shared, upon each occasion when the user performs or encounters the particular action or entity using the local user computing device. Another set of graphical control elements 610 governs the operation of the presentation-triggering component 306 by activating (and/or deactivating) particular invocation rules. Each invocation rule determines whether the PCS 302 should operate in the private state or the shared state, given a specified set of contextual factors. Another set of graphical control elements 612 allows a user to create new invocation rules. Another set of graphical control elements 614 allows the user to activate or create rules that govern the operation of the presentation-generating component 308. For instance, these rules can specify what content items are used to construct a privacy screen, and how these content items are to be arranged on the privacy screen. Another set of graphical control elements (not shown) allows a user to set and/or view permissions associated with other people, etc.

The above configuration options are cited by way of illustration, not limitation. In other implementations, the configuration component 508 can allow the user to configure the operation of the PCS 302 in additional ways, not described above. Or the configuration component 508 can omit one or more of the configuration options shown in FIG. 6 and described above.

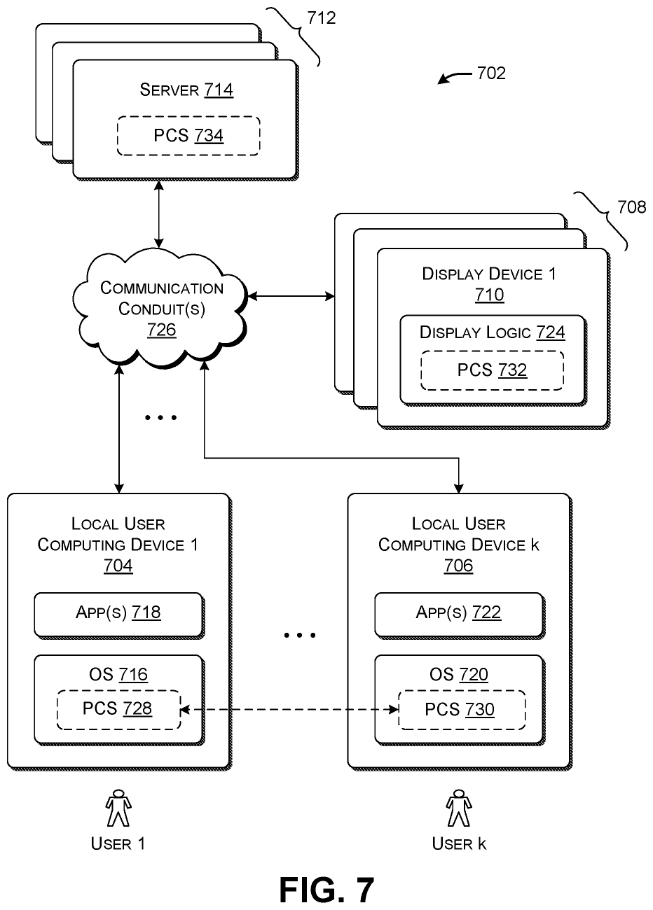

FIG. 7 shows illustrative computing equipment 702 that can be used to implement the PCS 302 of FIG. 3. The computing equipment 702 includes one or more local user computing devices (including representative local user computing devices (704, 706)), one or more display devices 708 (including representative display device 710), and one or more servers 712 (including representative server 714). Each local user computing device includes an operating system (OS) and one or more local applications. For instance, the first local user computing device 704 includes an OS 716 and one or more applications 718, and the second local user computing device 706 includes an OS 720 and one or more applications 722. The display device 710 is an “intelligent” display device that includes display logic 724 that governs how information is presented on the display device 710. Other display devices (not shown) may omit such display logic. One or more communication conduits 726 couple the above-described components together. The communication conduits 726 may allow for the local exchange of information and instructions among locally-situated devices (e.g., via direct point-to-point communication or by a local area network, etc.). In addition, the communication conduits 726 may include a computer network that connects any local device to the remote servers 712 (e.g., via a wide area network such as the Internet).

Each of the above-described components can include a local instantiation of the PCS 302 or at least parts thereof. For instance, the OS 716 of the local user computing device 704 can have a local instantiation 728 of the PCS 302, the OS 720 of the local user computing device 706 can include a local instantiation 730 of the PCS 302, the display logic 724 of the display device 710 can include a local instantiation 732 of the PCS 302, and the representative server 714 can include a local instantiation 734 of the PCS 302. This implementation is merely illustrative. For example, in another implementation, an application running on a local user computing device can execute one or more functions of the PCS 302.

In a standalone mode, each local user computing device uses its local instantiation of the PCS 302 to determine whether it should operate in a private state or a shared state, with respect to information its projects on a display device. In a cooperative mode, two or more local user computing devices (e.g., devices 704 and 706) communicate to determine whether they should enter a private state or whether they should contribute to a shared privacy screen. For instance, these local user computing devices (704, 706) can communicate by direct device-to-device (peer-to-peer) wireless connection, by a local area network, or by any other mechanism. In a centralized mode of operation, a centralized instantiation of the PCS 302 (such as the instantiation 734 running on the server 714) can determine whether any given local user computing device should operate in the private state or the shared state at any given moment. In a distributed mode, a centralized instantiation of the PCS 302 can cooperatively work with a local instantiation of the PCS 302 to determine whether any given local user computing device should operate in the private state or the shared state at any given time. For instance, the instantiation 734 of the PCS 302 running on the server 714 can govern the presentation of a privacy screen when two or more local user computing devices seek to contribute to that privacy screen; otherwise, the computing equipment 702 can rely on each local user computing device to govern the generation of a privacy screen.

The above-described implementations of the PCS 302 are set forth in the spirit of illustration, not limitation. Still other implementations can allocate the functions of the PCS 302 described with reference to FIGS. 1-6 to one or more devices in yet other ways, compared to the examples set forth above.

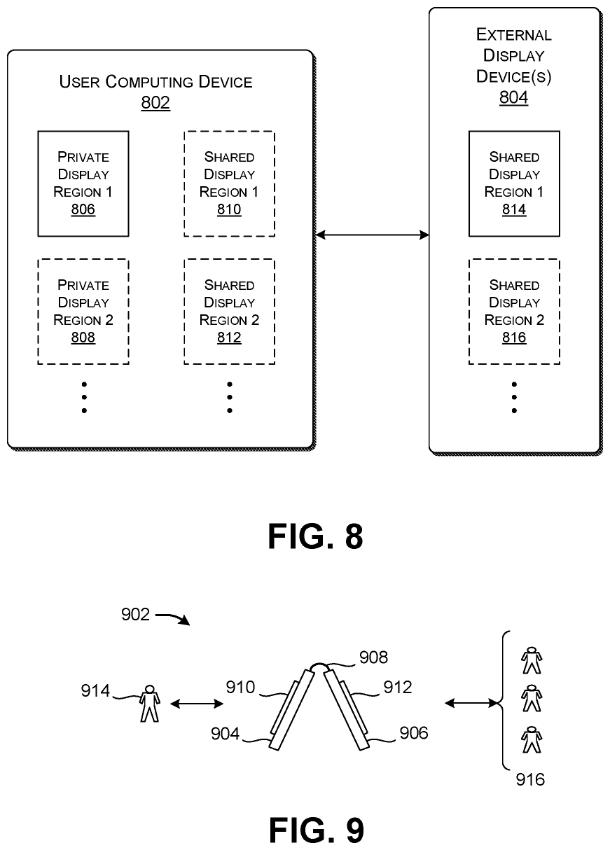

FIG. 8 shows a representative local user computing device 802 that interacts with at least one representative external display device 804. An external display device is considered “external” relative to a local user computing device when it does not form an integral part of that local user computing device. FIG. 8 indicates that the local user computing device 802 can optionally include one or more display devices that host one or more private displays regions (806, . . . , 808) and optionally include one or more shared display regions (810, . . . 812). The representative external display device 804 can host one or more shared display regions (814, . . . , 816). Although not shown, the external display device 804 can also optionally provide one or more private display regions associated with different respective users.

FIG. 9 shows a cross-section of a local user computing device 902 having two parts (904, 906) joined by a hinge 908. Two display devices (910, 912) are attached to the two respective parts (904, 906). In a tented mode (shown in FIG. 9), a first display device 910 is oriented such that it faces a user 914 who operates the local user computing device 902, while a second display device 912 is oriented way from the user 914 towards one or more other users 916 (if any). In this configuration, the first display device 910 operates as a private-region-hosting (PRH) display device, while the second display device 912 operates as a shared-region-hosting (SRH) display device. The configuration component 508 (of FIG. 5) can determine the status of each of the first and second display devices (910, 912) based on one or more contextual factors, such as the position of the parts (904, 906) relative to each other, the presence of other users 916, the location of the user 914, the locations of the other users 916, and so on.

Note that FIG. 9 represents just one example of a local user computing device having two or more display devices, any of which can provide a private display region and any of which can provide a shared display region. Any computing device having repositionable display devices can achieve the same effect, including a computing device having a bendable display device, a portion of which can be bent to face the users 916. Other computing devices may be specifically designed to include both a private display region and a public display region.

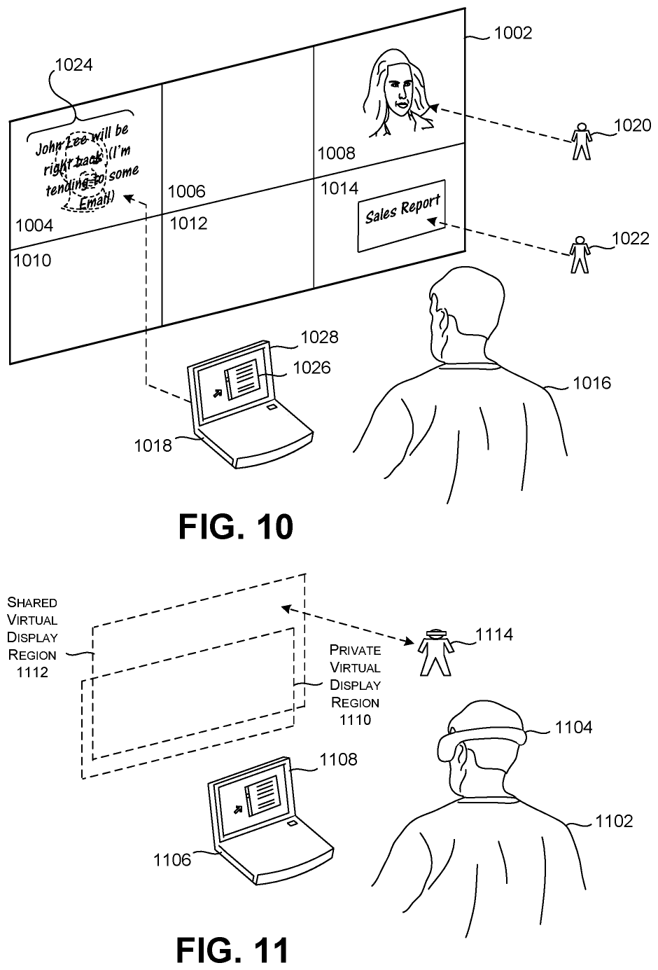

FIG. 10 shows an example of a display device 1002 that includes plural shared display regions (1004, 1006, 1008, 1010, 1012, 1014). The illustrated number of these shared display regions is merely illustrative; other implementations of the display device 1002 can provide any number n of shared display regions. Alternatively, FIG. 10 can show a presentation screen projected by a display device, where that presentation screen include plural shared display regions.

Assume that, in this merely illustrative scenario, plural users contribute content to respective shared display regions. For example, a user 1016 interacts with a local user computing device 1018. The local user computing device 1018, in turn, projects shared content to a shared display region 1004. Another user 1020 operates a local user computing device (not shown) that contributes to a shared display region 1008. Another user 1022 operates a local user computing device (not shown) that contributes to a shared display region 1014, and so on. Note that, while a single user contributes to each shared display region, the region is considered “shared” because two or more people are presumed to view the shared display region. But unlike the example of FIG. 1, the other users may or may not be present in the same room together.

In one manner of operation, each local user computing device controls whether it is operating in a private state or a shared state. When operating in a private state, each local user computing device may (optionally) display first content on its own local display device (if any), and second content on its shared display region, where the second content constitutes a privacy screen that blocks one or more display elements that would be projected onto the shared display region, but for the use of the privacy screen. When operating in a shared state, the PCS 302 running on the local user computing device removes the privacy screen, and thereby removes the blocking role performed by the privacy screen.

For instance, the user 1016 is currently interacting with a file system on his local user computing device 1018. This causes the PCS 302 that runs on the local user computing device 1018 to enter the private state. This, in turn, causes the PCS 302 to display a privacy screen 1024 on the shared display region 1004. In this merely illustrative case, the privacy screen 1024 includes a still frame of the user 1016, taken at the moment that the PCS 302 entered the private state. The privacy screen 1024 also includes a message that informs other users that the user 1016 has suspended his presentation and will return in due course. During the private state, the user 1016 may continue to interact with the file system. More specifically, FIG. 10 shows the user 1016 interacting with the file system via a graphical element 1026 presented by the PCS 302 on a local display device 1028 (which hosts a private display region). The privacy screen 1024 blocks the presentation of the graphical element 1026 on the shared display region 1004.

Note that FIG. 10 represents just one example of a display device that can accommodate contributions from two or more people. The principles described above apply to any wall-mounted display device, tabletop display device, multi-panel display device, etc. In other examples, a central PCS can produce a shared screen that combines contributions from plural contributors, without necessarily routing content from each contributor to a particular section of the shared screen. That implementation of the PCS 302 can use environment-specific policy logic to determine how to combine the contributions from plural participants. For instance, the PCS 302 can route the contribution associated with a current presenter to a main section of a shared screen, and the contributions of other people to one or more satellite regions of the shared screen.

FIG. 11 shows an example in which a user 1102 uses a head-mounted display (HMD) 1104 (or any other kind of mixed-reality device) to produce a mixed-reality presentation. As used herein, a mixed-reality presentation includes any kind of presentation that includes at least some virtual content. The HDM 1104 constitutes a first local user computing device. At the same time, the user 1102 may optionally also interact with another physical user computing device 1106 having a physical local display device 1108. For instance, the HDM 1104 can include a partially-transparent display device. The HDM 1104 presents virtual objects on the partially-transparent display device, which collectively constitute virtual content. At the same time, the user may see physical objects (including the physical local display device 1108) through the partially-transparent display device. Although not shown, the user 1102 can also interact with one or more physical external display devices, such as a physical projector device, while wearing the HMD 1104.

The HMD 1104 can produce a private virtual display region 1110 by presenting virtual objects that only the user 1102 is permitted to see. Alternatively, or in addition the HMD 1104 can produce a shared virtual display region 1112 by presenting virtual objects that one or more other users (besides the user 1102) are permitted to see by donning respective HMDs. Thus, the PCS 302 in the scenario of FIG. 11 can optionally present a private display region on either (or both) of the local display device 1108 or the private virtual display region 1110. The PCS 302 can present a shared display region on either (or both) of an external display device (not shown) or the shared virtual display region 1112.

Note that FIG. 11 graphically shows the private virtual region 1110 as a display space that overlaps the shared virtual display region 1112. What this means is that the HMD 1104 merges the virtual objects in the private space with the virtual objects in the shared space. The user 1102 will perceive a single virtual world having private and shared objects. But another user will not see the virtual objects associated with the private world of the user 1102.

The PCS 302 can produce a privacy screen on any shared display region in the scenario of FIG. 11 in the same manner described above for non-virtual implementations. For example, assume that the user 1102 is giving a demonstration to other users via a shared virtual world, delivered to the other users through the shared virtual display region 1112. For instance, a user 1114 can view the demonstration via the shared virtual display region 1112, via his own HMD. The user 1102 can explicitly or implicitly invoke the private state at any given time to suspend the demonstration, upon which the PCS 302 projects a privacy screen to the shared virtual display region 1112. While in the private state, the user 1102 may perform any private transaction via a private display region, such as the private virtual display region 1110 provided by the HMD 1104, or a private display region provided by the local display device 1108. The privacy screen projected on the shared display region 1112 will not show any private graphical elements that appear in the private display region. More generally, the privacy screen operates to block at least some content that would ordinarily be projected to the shared virtual display region 1112. The user can return to the shared state upon completing his private transaction by performing any action that invokes the shared state.

B. Illustrative Processes

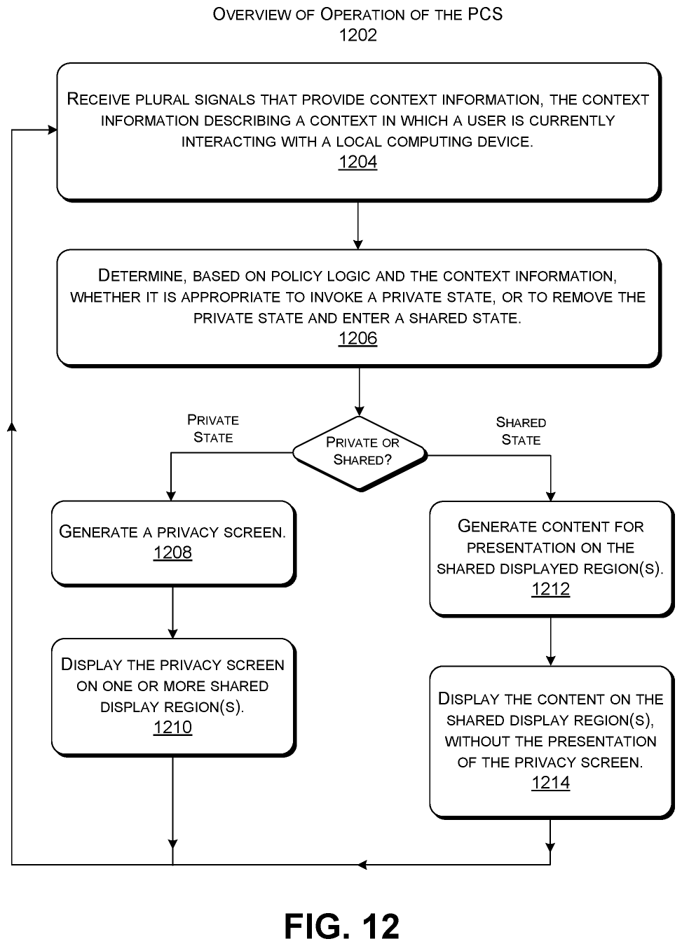

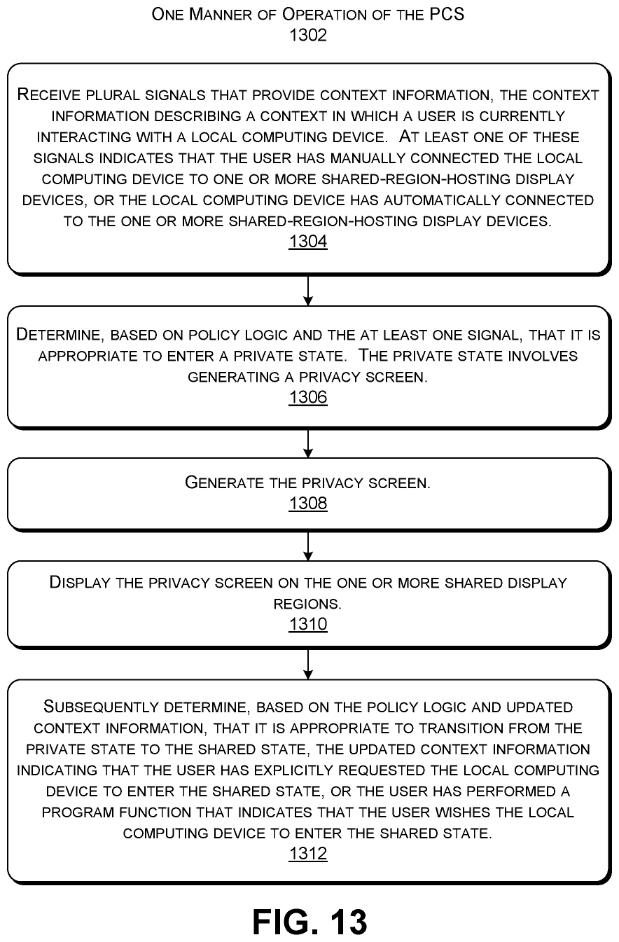

FIGS. 12 and 13 show processes (1202, 1302) that explain the operation of the PCS 302 of Section A in flowchart form. Since the principles underlying the operation of the PCS 302 have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

More specifically, FIG. 12 shows a process 1202 that provides an overview of one manner of operation of the PCS 302 of FIG. 3. In operation 1204, the PCS 302 receives plural signals that provide context information. The context information describes a context in which a user is currently interacting with a local user computing device. In operation 1206, the PCS 302 determines, based on policy logic and the context information, whether it is appropriate to invoke a private state, or to remove the private state and enter a shared state. The private state corresponds to a state in which the local user computing device displays content on one or more shared display regions provided by one or more shared-region-hosting (SRH) display devices. The content operates as a privacy screen that blocks at least one display item that would be projected by the local user computing device to the shared display region(s), but for the privacy screen. The shared state corresponds to a state in which the privacy screen is removed.

Assuming that the private state has been invoked, in operation 1208, the PCS 302 generates the privacy screen. In operation 1210, the PCS 302 displays the privacy screen on the shared display region(s).

Assuming that the shared state has been invoked, in operation 1212, the PCS 302 generates content for presentation on the shared display region(s). In operation 1214, the PCS 302 displays the generated content on the shared display region(s), without the presentation of a privacy screen.

In some but not all implementations, the PCS 302 also generates information for presentation on one or more private shared regions on one or more private-region-hosting (PRH) display devices, in both the private and shared states. For instance, in the shared state, the PCS 302 can present at least one display item on the private shared region(s) that is blocked by the privacy screen on the shared display region(s).

FIG. 13 shows a process that represents one manner of operation of the PCS 302 with respect to a particular use scenario, such as the scenario described with reference to FIG. 1. In operation 1304, the PCS 302 receives plural signals that provide context information. The context information describes a context in which the user is currently interacting with a local user computing device. At least one signal of the plural signals indicates that the user has manually connected the local user computing device to one or more SRH display devices, or the local user computing device has automatically connected to the one or more SRH display devices. In operation 1306, the PCS 302 determines, based on policy logic and the signal(s) indicating that the user has made a connection, that it is appropriate to enter a private state, e.g., in one case, without first entering a shared state. In operation 1308, the PCS 302 generates a privacy screen. In operation 1310, the PCS 302 displays the privacy screen on the one or more shared display regions. In operation 1312, the PCS 302 subsequently determines, based on the policy logic and updated context information, that it is appropriate to transition from the private state to the shared state. More specifically, the updated context information indicates that the user has explicitly requested the local user computing device to enter the shared state, and/or the user has performed a program function that indicates that the user wishes the local user computing device to enter the shared state.

C. Representative Computing Functionality

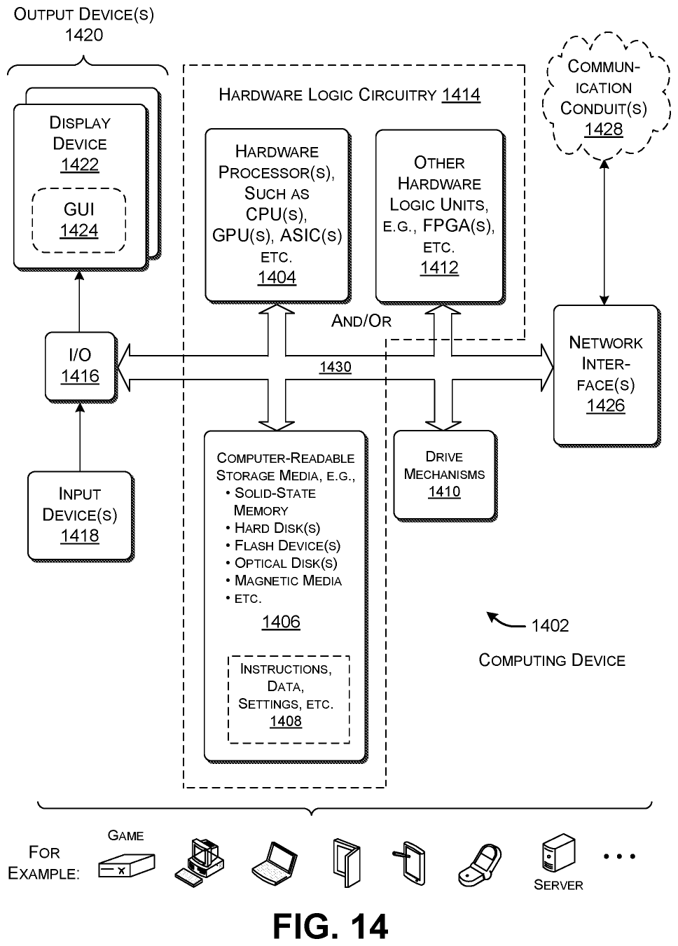

FIG. 14 shows a computing device 1402 that can be used to implement any aspect of the mechanisms set forth in the above-described figures. For instance, with reference to FIG. 7, the type of computing device 1402 shown in FIG. 14 can be used to implement any local user computing device, any intelligent display device, any server, etc. In all cases, the computing device 1402 represents a physical and tangible processing mechanism.

The computing device 1402 can include one or more hardware processors 1404. The hardware processor(s) 1402 can include, without limitation, one or more Central Processing Units (CPUs), and/or one or more Graphics Processing Units (GPUs), and/or one or more Application Specific Integrated Circuits (ASICs), etc. More generally, any hardware processor can correspond to a general-purpose processing unit or an application-specific processor unit.

The computing device 1402 can also include computer-readable storage media 1406, corresponding to one or more computer-readable media hardware units. The computer-readable storage media 1406 retains any kind of information 1408, such as machine-readable instructions, settings, data, etc. Without limitation, for instance, the computer-readable storage media 1406 may include one or more solid-state devices, one or more magnetic hard disks, one or more optical disks, magnetic tape, and so on. Any instance of the computer-readable storage media 1406 can use any technology for storing and retrieving information. Further, any instance of the computer-readable storage media 1406 may represent a fixed or removable unit of the computing device 1402. Further, any instance of the computer-readable storage media 1406 may provide volatile or non-volatile retention of information.

The computing device 1402 can utilize any instance of the computer-readable storage media 1406 in different ways. For example, any instance of the computer-readable storage media 1406 may represent a hardware memory unit (such as Random Access Memory (RAM)) for storing transient information during execution of a program by the computing device 1402, and/or a hardware storage unit (such as a hard disk) for retaining/archiving information on a more permanent basis. In the latter case, the computing device 1402 also includes one or more drive mechanisms 1410 (such as a hard drive mechanism) for storing and retrieving information from an instance of the computer-readable storage media 1406.

The computing device 1402 may perform any of the functions described above when the hardware processor(s) 1404 carry out computer-readable instructions stored in any instance of the computer-readable storage media 1406. For instance, the computing device 1402 may carry out computer-readable instructions to perform each block of the processes described in Section B.

Alternatively, or in addition, the computing device 1402 may rely on one or more other hardware logic units 1412 to perform operations using a task-specific collection of logic gates. For instance, the hardware logic unit(s) 1412 may include a fixed configuration of hardware logic gates, e.g., that are created and set at the time of manufacture, and thereafter unalterable. Alternatively, or in addition, the other hardware logic unit(s) 1412 may include a collection of programmable hardware logic gates that can be set to perform different application-specific tasks. The latter category of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 14 generally indicates that hardware logic circuitry 1414 includes any combination of the hardware processor(s) 1404, the computer-readable storage media 1406, and/or the other hardware logic unit(s) 1412. That is, the computing device 1402 can employ any combination of the hardware processor(s) 1404 that execute machine-readable instructions provided in the computer-readable storage media 1406, and/or one or more other hardware logic unit(s) 1412 that perform operations using a fixed and/or programmable collection of hardware logic gates. More generally stated, the hardware logic circuitry 1414 corresponds to one or more hardware logic units of any type(s) that perform operations based on logic stored in and/or otherwise embodied in the hardware logic unit(s).

In some cases (e.g., in the case in which the computing device 1402 represents a user computing device), the computing device 1402 also includes an input/output interface 1416 for receiving various inputs (via input devices 1418), and for providing various outputs (via output devices 1420). Illustrative input devices include a keyboard device, a mouse input device, a touchscreen input device, a digitizing pad, one or more static image cameras, one or more video cameras, one or more depth camera systems, one or more microphones, a voice recognition mechanism, any movement detection mechanisms (e.g., accelerometers, gyroscopes, etc.), and so on. One particular output mechanism may include a display device 1422 and an associated graphical user interface presentation (GUI) 1424. The display device 1422 may correspond to a liquid crystal display device, a light-emitting diode display (LED) device, a projection mechanism, etc. Other output devices include a printer, one or more speakers, a haptic output mechanism, an archival mechanism (for storing output information), and so on. The computing device 1402 can also include one or more network interfaces 1426 for exchanging data with other devices via one or more communication conduits 1428. One or more communication buses 1430 communicatively couple the above-described units together.

The communication conduit(s) 1428 can be implemented in any manner, e.g., by a local area computer network, a wide area computer network (e.g., the Internet), point-to-point connections, etc., or any combination thereof. The communication conduit(s) 1428 can include any combination of hardwired links, wireless links, routers, gateway functionality, name servers, etc., governed by any protocol or combination of protocols.

FIG. 14 shows the computing device 1402 as being composed of a discrete collection of separate units. In some cases, the collection of units may correspond to discrete hardware units provided in a computing device chassis having any form factor. FIG. 14 shows illustrative form factors in its bottom portion. In other cases, the computing device 1402 can include a hardware logic unit that integrates the functions of two or more of the units shown in FIG. 1. For instance, the computing device 1402 can include a system on a chip (SoC or SOC), corresponding to an integrated circuit that combines the functions of two or more of the units shown in FIG. 14.

The following summary provides a non-exhaustive set of illustrative aspects of the technology set forth herein.

According to a first aspect, one or more computing devices for displaying content are described. The computing device(s) include hardware logic circuitry, the hardware logic circuitry, in turn, including: (a) one or more hardware processors that perform operations by executing machine-readable instructions stored in a memory, and/or (b) one or more other hardware logic units that perform the operations using a task-specific collection of logic gates. The operations include: receiving plural signals that provide context information, the context information describing a context in which a user is currently interacting with a local user computing device, and then determining, based on policy logic and the context information, whether it is appropriate to invoke a private state, or to remove the private state and enter a shared state. The private state corresponds to a state in which the local user computing device displays content on one or more shared display regions provided by one or more shared-region-hosting display devices, the content operating as a privacy screen that blocks at least one display item that would be projected by the local user computing device to the one or more shared display regions, but for the privacy screen. The shared state corresponds to a state in which the privacy screen is removed. The operations further include generating the privacy screen when the determining ascertains that it is appropriate to enter the private state, and displaying the privacy screen on the one or more shared display regions. The local user computing device remains connected to the one or more shared-region-hosting display devices while in both the private state and the shared state.

According to a second aspect, in the private state, the local user computing device displays one or more display items on one or more private display regions provided by one or more private-region-hosting display devices. Here, the privacy screen blocks presentation of the one or more display items.

According to a third aspect, the plural signals include at least one signal that indicates that the user has provided a command that requests the local user computing device to enter the private state or the shared state.

According to a fourth aspect, the plural signals include at least one signal that indicates that the user has manually connected the local user computing device to at least one shared-region-hosting display device, or the local user computing device has automatically connected to the at least one shared-region-hosting display device. Here, the operation of determining ascertains, based on the policy logic and the at least one signal, that it is appropriate to enter the private state.

According to a fifth aspect, the plural signals include at least one signal that indicates that the user has interacted with a particular program function or application provided by the local user computing device.

According to a sixth aspect, relating to the fifth aspect, the policy logic indicates that information that reveals interaction by the user with the particular program function or application is not to be shared with others user. Further, the operation of determining ascertains, based on the policy logic and the at least one signal, that it is appropriate to transition from the shared state to the private state.

According to a seventh aspect, relating to the fifth aspect, the policy logic indicates that the user interacts with the particular program function or application when the user wishes to share content with one or more other users. Here, the operation of determining ascertains, based on the policy logic and the at least one signal, that it is appropriate to transition from the private state to the shared state.

According to an eighth aspect, the plural signals include at least one signal that identifies a kind of at least one shared-region-hosting display device to which the local user computing device is currently connected.

According to a ninth aspect, the plural signals include at least one signal that identifies a current location of the user.

According to a tenth aspect, the plural signals include: at least one signal that specifies an identity of at least one other user who is interacting with the one or more shared display regions, or is expected to interact with the one or more shared display regions; and at least one signal that provides permission information that describes an extent to which the at least one other user has been given permission to view content provided by the user of the local user computing device.

According to an eleventh aspect, the plural signal include: at least one signal that identifies a current configuration of a user interface presentation with which the user is currently interacting; and/or at least one signal that identifies a current graphical object on the user interface presentation which the user is presumed to be currently focusing on.

According to a twelfth aspect, the operation of generating of the privacy screen includes presenting default display content on the one or more shared display regions, in lieu of the at least one display item that that would be displayed in the one or more shared display regions, but for the privacy screen.

According to a thirteenth aspect, relating to the twelfth aspect, the default display content conveys information about the user of the local user computing device, and/or information previously selected by the user.

According to a fourteenth aspect, relating to the twelfth aspect, the default display content corresponds to content that has been previously presented on the one or more shared display regions in a current presentation session.

According to a fifteenth aspect, relating to the twelfth aspect, the default display content includes content supplied by the local user computing device and at least one other local user computing device, the at least one other local user computing device also having access to the one or more shared-region-hosting display devices.

According to a sixteenth aspect, the operations further comprise receiving configuration information that specifies at least: a status of at least one location as being private or shared; a status of at least one display device as being private or shared; and a status of at least one program function as being private or shared.

According to a seventeenth aspect, at least one shared display region includes content provided by the user and at least one other user.

According to an eighteenth aspect, at least one private display region and/or at least one shared display region is a virtual display produced by a mixed-reality device.

According to a nineteenth aspect, a method is described for presenting content. The method includes: receiving plural signals that provide context information, the context information describing a context in which a user is currently interacting with a local user computing device, at least one signal of the plural signals indicating that the user has manually connected the local user computing device to one or more shared-region-hosting display devices, or the local user computing device has automatically connected to the one or more shared-region-hosting display devices. The method then includes determining, based on policy logic and the at least one signal, that it is appropriate to enter a private state. The private state corresponds to a state in which the local user computing device displays content on one or more shared display regions provided by the one or more shared-content-hosting display devices, the content operating as a privacy screen that blocks at least one display item that would be projected by the local user computing device to the one or more shared display regions, but for the privacy screen. The shared state corresponds to a state in which the privacy screen is removed. The method further includes: generating the privacy screen; displaying the privacy screen on the one or more shared display regions; and subsequently determining, based on the policy logic and updated context information, that it is appropriate to transition from the private state to the shared state. The updated context information indicates that the user has explicitly requested the local user computing device to enter the shared state, or the user has performed a program function that indicates that the user wishes the local user computing device to enter the shared state.

According to a twentieth aspect, a computer-readable storage medium for storing computer-readable instructions is described. The computer-readable instructions, when executed by one or more hardware processors, perform a method that includes receiving plural signals that provide context information, the context information describing a context in which a user is currently interacting with a local user computing device. The method then includes determining, based on policy logic and the context information, whether it is appropriate to invoke a private state, or to remove the private state and enter a shared state. The private state corresponds to a state in which the local user computing device displays first content on one or more private display regions provided by one or more private-region-hosting display devices, while simultaneously presenting second content on one or more shared display regions provided by one or more shared-region-hosting display devices, the second content operating as a privacy screen that blocks at least one display item that would be projected by the local user computing device to the one or more shared display regions, but for the privacy screen. The shared state corresponds to a state in which the privacy screen is removed.

A twenty-first aspect corresponds to any combination (e.g., any logically consistent permutation or subset) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computing devices for displaying content, comprising:
hardware logic circuitry, the hardware logic circuitry including: (a) one or more hardware processors that perform operations by executing machine-readable instructions stored in a memory, and/or (b) one or more other hardware logic units that perform the operations using a task-specific collection of logic gates, the operations including:
receiving plural signals that provide context information, the context information describing a context in which a user is currently interacting with a local user computing device;
determining, based on policy logic and the context information, whether it is appropriate to invoke a private state, or to remove the private state and enter a shared state,
the private state corresponding to a state in which the local user computing device displays content on one or more shared display regions provided by one or more shared-region-hosting display devices, the content operating as a privacy screen that blocks at least one display item that would be projected by the local user computing device to said one or more shared display regions, but for the privacy screen, and
the shared state corresponding to a state in which the privacy screen is removed; and
generating the privacy screen when said determining ascertains that it is appropriate to enter the private state, and displaying the privacy screen on said one or more shared display regions,
the local user computing device remaining connected to said one or more shared-region-hosting display devices while in both the private state and the shared state.

2. The one or more computing devices of claim 1,
wherein, in the private state, the local user computing device displays one or more display items on one or more private display regions provided by one or more private-region-hosting display devices, and
wherein the privacy screen blocks presentation of said one or more display items.

3. The one or more computing devices of claim 1, wherein the plural signals include at least one signal that indicates that the user has provided a command that requests the local user computing device to enter the private state or the shared state.

4. The one or more computing devices of claim 1,
wherein the plural signals include at least one signal that indicates that the user has manually connected the local user computing device to at least one shared-region-hosting display device, or the local user computing device has automatically connected to said at least one shared-region-hosting display device, and
wherein said determining ascertains, based on the policy logic and said at least one signal, that it is appropriate to enter the private state.

5. The one or more computing devices of claim 1, wherein the plural signals include at least one signal that indicates that the user has interacted with a particular program function or application provided by the local user computing device.

6. The one or more computing devices of claim 5,
wherein the policy logic indicates that information that reveals interaction by the user with the particular program function or application is not to be shared with others user, and
wherein said determining ascertains, based on the policy logic and said at least one signal, that it is appropriate to transition from the shared state to the private state.

7. The one or more computing devices of claim 5,
wherein the policy logic indicates that the user interacts with the particular program function or application when the user wishes to share content with one or more other users, and
wherein said determining ascertains, based on the policy logic and said at least one signal, that it is appropriate to transition from the private state to the shared state.

8. The one or more computing devices of claim 1, wherein the plural signals include at least one signal that identifies a kind of at least one shared-region-hosting display device to which the local user computing device is currently connected.

9. The one or more computing devices of claim 1, wherein the plural signals include at least one signal that identifies a current location of the user.

10. The one or more computing devices of claim 1, wherein the plural signals include:
at least one signal that specifies an identity of at least one other user who is interacting with said one or more shared display regions, or is expected to interact with said one or more shared display regions; and
at least one signal that provides permission information that describes an extent to which said at least one other user has been given permission to view content provided by the user of the local user computing device.

11. The one or more computing devices of claim 1, wherein the plural signals include:
at least one signal that identifies a current configuration of a user interface presentation with which the user is currently interacting; and/or
at least one signal that identifies a current graphical object on the user interface presentation which the user is presumed to be currently focusing on.

12. The one or more computing devices of claim 1, wherein said generating of the privacy screen includes presenting default display content on said one or more shared display regions, in lieu of said at least one display item that that would be displayed in said one or more shared display regions, but for the privacy screen.

13. The one or more computing devices of claim 12, wherein the default display content conveys information about the user of the local user computing device, and/or information previously selected by the user.

14. The one or more computing devices of claim 12, wherein the default display content corresponds to content that has been previously presented on said one or more shared display regions in a current presentation session.

15. The one or more computing devices of claim 12, wherein the default display content includes content supplied by the local user computing device and at least one other local user computing device, said at least one other local user computing device also having access to said one or more shared-region-hosting display devices.

16. The one or more computing devices of claim 1, wherein the operations further comprise receiving configuration information that specifies at least:
a status of at least one location as being private or shared;
a status of at least one display device as being private or shared; and
a status of at least one program function as being private or shared.

17. The one or more computing devices of claim 1, wherein at least one shared display region includes content provided by the user and at least one other user.

18. The one or more computing devices of claim 1, wherein at least one private display region and/or at least one shared display region is a virtual display produced by a mixed-reality device.

19. A method for presenting content, comprising:
receiving plural signals that provide context information, the context information describing a context in which a user is currently interacting with a local user computing device,
at least one signal of the plural signals indicating that the user has manually connected the local user computing device to one or more shared-region-hosting display devices, or the local user computing device has automatically connected to said one or more shared-region-hosting display devices;
determining, based on policy logic and said at least one signal, that it is appropriate to enter a private state,
the private state corresponding to a state in which the local user computing device displays content on one or more shared display regions provided by said one or more shared-content-hosting display devices, the content operating as a privacy screen that blocks at least one display item that would be projected by the local user computing device to said one or more shared display regions, but for the privacy screen,
the shared state corresponding to a state in which the privacy screen is removed;
generating the privacy screen;
displaying the privacy screen on said one or more shared display regions; and
subsequently determining, based on the policy logic and updated context information, that it is appropriate to transition from the private state to the shared state,
the updated context information indicating that the user has explicitly requested the local user computing device to enter the shared state, or the user has performed a program function that indicates that the user wishes the local user computing device to enter the shared state.

20. A computer-readable storage medium for storing computer-readable instructions, the computer-readable instructions, when executed by one or more hardware processors, performing a method that comprises:
receiving plural signals that provide context information, the context information describing a context in which a user is currently interacting with a local user computing device;
determining, based on policy logic and the context information, whether it is appropriate to invoke a private state, or to remove the private state and enter a shared state,
the private state corresponding to a state in which the local user computing device displays first content on one or more private display regions provided by one or more private-region-hosting display devices, while simultaneously presenting second content on one or more shared display regions provided by one or more shared-region-hosting display devices, the second content operating as a privacy screen that blocks at least one display item that would be projected by the local user computing device to said one or more shared display regions, but for the privacy screen, and
the shared state corresponding to a state in which the privacy screen is removed.
